(19) United States
(12) Patent Application Publication
(10) Pub. No.: US 2023/0105933 A1
(43) Pub. Date: Apr. 6, 2023

(54) Remote Cattle Detection and Trapping System

(71) Applicant: UNM RAINFOREST INNOVATIONS, Albuquerque, NM (US)

(72) Inventor: Jonathan Carter Hebert, Albuquerque, NM (US)

(73) Assignee: UNM RAINFOREST INNOVATIONS, Albuquerque, NM (US)

(21) Appl. No.: 18/073,763

(22) Filed: Dec. 2, 2022

Related U.S. Application Data
(60) Provisional application No. 62/942,297, filed on Dec. 2, 2019.
(60) Provisional application No. 63/120,395, filed on Dec. 2, 2020.
(60) Provisional application No. 63/285,560, filed on Dec. 3, 2021.

(51) Int. Cl. A01K 29/00; A01K 3/00

(52) U.S. Cl. CPC A01K 29/005; A01K 3/004

(57) ABSTRACT

A remote cattle securing and trapping system that allows a virtual rancher to detect cattle entering or exiting a pen at a remote location using an image recognition subsystem that includes capturing images using a camera, that determines which motion activates an electronics communication subsystem to send images via a virtual platform to a virtual rancher, and the virtual platform can be utilized to activate a relay controlled latch system that opens or closes a cattle gate at the remote location.

### CROSS-REFERENCE TO RELATED APPLICATIONS

This application claims priority to provisional U.S. Pat. Application Ser. No. 63/285,560 filed Dec. 03, 2021, the disclosure of which is herein incorporated by reference in its entirety.

### TECHNICAL FIELD

The subject matter described herein relates generally to a system and method for trapping animals, and, more particularly, to a system that actuates a relay controlled latch to close a gate via a secure network and trap cattle inside of a remote pen.

### BACKGROUND

Wrangling or herding of range cattle is a suitable solution for domesticated cattle. When open range cattle are without regular human contact they can revert to wild behaviors and fail to herd safely for harvesting and clearing of rangeland. When cattle won’t herd, they are roped, but roping can only be done on yearling cows that are generally less than about 700 lbs. Large wild bulls are typically shot and killed to remove from rangeland as they are too dangerous to attempt to wrangle or rope.

Both herding and roping are extremely resource intensive and dangerous. It would be desirable for a system and method to herd range cattle and other wild animals that is safer and requires less resources.

### SUMMARY

The following presents a simplified summary in order to provide a basic understanding of some aspects of one or more embodiments of the present teachings. This summary is not an extensive overview, nor is it intended to identify key or critical elements of the present teachings, nor to delineate the scope of the disclosure. Rather, its primary purpose is merely to present one or more concepts in simplified form as a prelude to the detailed description presented later.

An embodiment animal detection and trapping system includes a spring loaded gate and relayed controlled latch subsystem, an electronic controls and communications subsystem, and a camera and image recognition subsystem.

An embodiment method for trapping animals includes detecting an animal within a trapping area by a camera subsystem; generating an image using data provided by the camera subsystem and a machine learning enabled detection algorithm that can differentiate motion in the trapping area; and sending a wireless signal to actuate a latch to trap the animal within the trapping area. The method may further include sending at least a portion of the image to a virtual platform.

### BRIEF DESCRIPTION OF THE DRAWINGS

The accompanying drawings, which are incorporated in and constitute a part of this specification, illustrate embodiments of the present teachings and together with the description, serve to explain the principles of the disclosure. In the figures:

FIG. 1 is a schematic drawing of an embodiment remote cattle securing and trapping system controlled over a wireless system from a separate location.

FIG. 2 is a method for securing and trapping cattle at a remote pen using the disclosed cattle trapping system.

It should be noted that some details of the FIGS. have been simplified and are drawn to facilitate understanding of the present teachings rather than to maintain strict structural accuracy, detail, and scale.

### DETAILED DESCRIPTION

Reference will now be made in detail to exemplary implementations of the present disclosure, examples of which are illustrated in the accompanying drawings. Wherever possible, the same reference numbers will be used throughout the drawings to refer to the same or like parts. In the following description, reference is made to the accompanying drawings that form a part thereof, and in which is shown by way of illustration specific exemplary implementations in which the present disclosure can be practiced. These implementations are described in sufficient detail to enable those skilled in the art to practice the present disclosure and it is to be understood that other implementations can be utilized and that changes can be made without departing from the scope of the present disclosure. The following description is, therefore, merely exemplary.

According to the present teachings, a secure, remote cattle detection and trapping system is provided. It enables a virtual rancher, for example, a person or a computer program, to receive notifications when cattle enters a pen, view the cattle via a camera subsystem, then actuate a relay controlled latch over a secure network to close a gate trapping cattle inside of the pen. The disclosed system is designed to prohibit unauthorized access of the electronic controls, the camera subsystem, and the relay controlled latch holding the spring-loaded gate. The disclosed system further enables simultaneous monitoring and harvesting of cattle, or other wildlife, at multiple sites separated by large areas of remote rangeland. Although references are made to cattle trapping in this disclosure, the trapping system described can also be used for detection and trapping of other animals, domestic, feral, or wild, such as sheep, goat, horses, elk, bison, javelinas, and the like.

The disclosed secure, remote cattle detection and trapping system allows a virtual rancher to capture cattle that are too wild and dangerous to capture using traditional methods like wrangling or roping. This system provides the ability to capture tens of huge wild bulls at a time that would have otherwise been shot to remove from the range. Heretofore, the largest wild cattle that could be caught without undue risk were yearlings weighing about 700 lbs. The disclosed system allows many bulls weighing over 2000 lbs to be safely and efficiently captured. Testing of the disclosed system has resulted in capture of more than 700 head of wild cattle, and 20 wild horses.

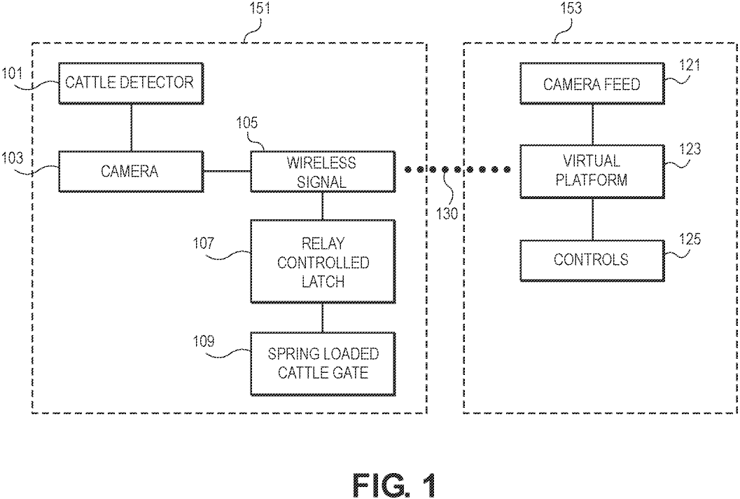

An embodiment remote cattle detection and trapping system is provided in FIG. 1. The system allows a virtual rancher to detect cattle entering a pen at a remote location 151 using a cattle detector 101 and a secure camera setup 103. After detecting cattle with the cattle detector 101, the camera system 103 can activate a wireless system 105 that includes electronic hardware systems that send and receive a wireless signal 130 (such as a wifi signal, a cellular signal, and/or a satellite signal). The wireless system 105 sends a camera feed wirelessly to a remote control interface (such as a virtual platform 123) that can be provided to a virtual rancher at the rancher’s location 153 away from the cattle pen’s remote location 151.

The virtual platform 123 can be set up to receive a camera feed 121 and/or a notification from the wireless system 105 automatically after the cattle detector 101 is triggered. When the virtual rancher receives notification and/ore camera feed 121 that cattle is detected at the remote location 151, the virtual rancher can activate a relay controlled latch 107 via virtual controls 125 through the virtual platform 123, and the relay controlled latch 107 can in turn activate the spring loaded cattle gate 109 to an open or closed position. The relay controlled latch 107 may be connected to a chain that is provided on the back of the spring loaded cattle gate at the remote cattle pen. During this process, the virtual rancher does not need to be physically present at the remote pen. The trapping system allows a rancher to detect, view, and trap cattle at a pen that is physically remote from the rancher.

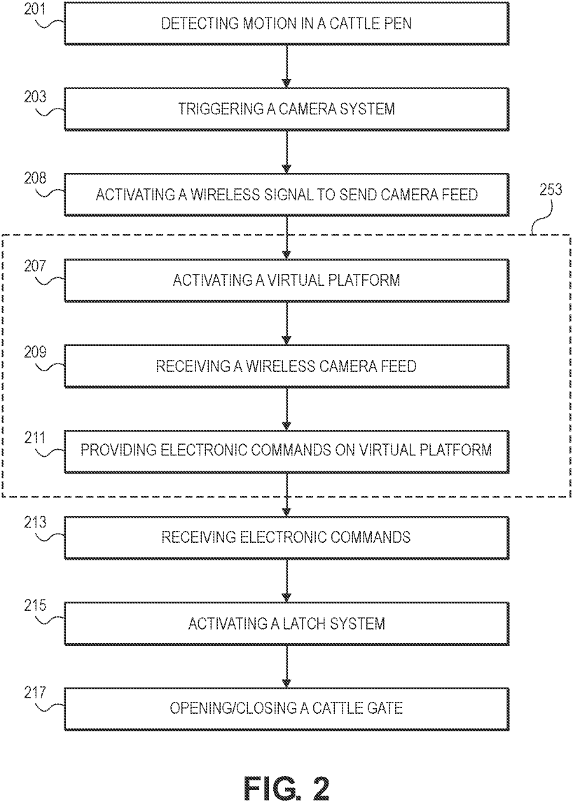

As shown in FIG. 2, an example method to secure and trap cattle at a remote cattle pen includes detecting motion in a cattle pen 201, triggering a camera system 203 that is connected to the motion detector, then activating an electronic system 205, such as a communications device, that is configured to send a wireless signal from the remote cattle pen to a virtual rancher. At the physical location 253 of the virtual rancher, which may be different from the remote cattle pen, the wireless signal sent from the remote location may activate a virtual platform 207 by receiving the wireless camera feed 209 on the virtual platform, and a virtual rancher can then determine the action required and provide electronic commands through the virtual platform 211. The electronic commands is received 213 by the camera system at the remote cattle pen, and a latch system is activated 215 to open or close a cattle gate 217 at the remote cattle pen.

In another embodiment, the virtual platform can be configured to automatically activate the relay controlled latch system 215 after cattle is detected, without a virtual rancher’s command at the time of the detection, to open or close the cattle gate. In this embodiment, the relay controlled latch automatically pulls on a chain attached to the cattle gate from either a closed position to an open position, or an open position to a closed position, such that cattle can move in and out of the cattle pen instantaneously without waiting on the virtual rancher’s action.

In an embodiment, the remote trapping system includes a secure camera and image recognition subsystem, an electronic control and communication system, and a relay controlled latch subsystem.

The camera and image recognition subsystem may detect cattle motion at the remote location, and may include a motion sensor, a camera sensor, an infrared sensor, or a combination thereof. In an embodiment, the cattle detector can be one camera or a series of cameras that detect motion within a defined region of the camera(s)’s view.

Notifications of motion and cattle detection are, for example, sent over via a Wifi Hotspot to a virtual rancher through a user interface, such as a virtual platform, on the virtual rancher’s phone/ipad/computer as an app or in a web browser to view the live camera stream and actuate the relay controlled latch holding the spring-loaded gate. The virtual rancher can make the decision to close the gate, delay closing the gate, or defer the decision to an artificial intelligence that calculates a decision based on the same information that a human virtual rancher would, such as the time of day, location, number of cattle inside trapping pen, number of cattle outside cattle pen, and direction of movement of cattle, etc. Each trapping system can have its own camera subsystem and a virtual rancher can view all of their trapping systems camera feeds and manage the traps from a virtual platform interface.

In an embodiment, the cattle trapping system requires the use of, for example an image recognition subsystem. The image recognition subsystem can use the camera subsystem’s camera feed, such as the video and audio and machine learning algorithms to detect cattle and their movements. The image recognition subsystem can take snapshots of the camera’s video stream, analyze them, and compress them to be sent as notifications to the virtual rancher’s virtual platform over a wireless network in short data bursts. The images are generated in part with machine learning enabled detection algorithms that can differentiate motion in the trapping area due to cattle or some other cause. This is referred to as “edge detection”. The image recognition subsystem can be run on the cattle trapping system’s primary electronic hardware, such as a computer, or on a separate hardware. The computer hardware may have a computer readable storage medium having program instructions embodied to receive and store the images and algorithms therein. In an embodiment the computer hardware can be a larger computer system that sends automatic calculations to an additional device, such as a cellphone, that is more portable to a virtual rancher.

The electronic hardware that sends and receives wireless signals, such as satellite, cellular, or wifi based signals, can have a bank of DC batteries with solar panels to power the electronic controls, communications, and camera subsystems for the remote cattle trapping system. In another embodiment, the system can support an AC power supply. The communication subsystem can have various connectivity options depending on whether cell phone signal is available. In an embodiment, a cellular signal based communication subsystem includes a cell phone signal repeater with directional antenna and a Wifi Hotspot that serves as the network connection for the electronic controls. The cellular signal based communication system may also include a RF communications device, such as a RF repeater. In another embodiment, a satellite based communication subsystem includes a satellite Wifi Hotspot and antenna capable of sending and receiving short data burst over a satellite network.

In an embodiment, the system’s electronic hardware can include a variety of power distribution terminals, circuit breakers, power converters, relays, and microcomputers. A DIN rail mounted switched circuit breaker can be used to power on and off the system from the DC battery bank or AC power supply. From the circuit breaker, power is connected to a DIN rail terminal block. Power is distributed from the terminal block to a USB power distribution hub, a network switch, a power converter for the cell phone Repeater (for a cellular based system), and a DIN rail mounted relay board. The USB power distribution hub provides USB power to the cellular or satellite Wifi Hotspots, the microcomputer, and the camera subsystem. The microcomputer connects to the Wifi Hotspot and then to a Virtual Private Network (VPN) and registers with a serverless electronic application or virtual platform running in the cloud.

The virtual platform routes Messages to and from cattle trapping systems to a virtual rancher. The virtual platform enables end-to-end encryption of all messages, password hardened encryption database storage of system data, and automated virtual rancher access provisioning via a specified cyber identification pairing of trapping system’s devices and possibly also other virtual ranches being monitored simultaneously. The virtual platform can be accessed through a phone app or web browser. Access is controlled through a secure login for virtual ranchers to view, control, and manage their cattle trapping systems and other remotely controlled devices. cattle trapping systems are paired to each of the remote ranches, and access can be provisioned automatically through the use of cyber identifications. Cattle trapping systems are deployed with a unique cyber identifications, and when activated they automatically connect to a virtual web application that enables virtual ranchers to view their camera feeds, receive notifications, manage system data, actuate each specific set of relay control latches to trap cattle at each of the pends.

In an embodiment, the virtual rancher sends a message to the microcomputer at the remote trapping site to shut the gate when cattle are detected, a device application can receive a message to shut the gate, the microcomputer toggles one of its General Input and Output Ports (GPIO) pins which activates one of the relays on the relay board, that in-turn activates the relay controlled latch holding the gate in place and then the spring loaded gate is released.

At the remote cattle pen, an exemplary cattle gate has a spring attached to the front of it, pulling it in the direction of closed. The spring is anchored to a fixed structure, e.g. an adjacent fence panel or post. A chain is attached to the back of the gate, and is used to secure the gate open by latching the other end of the chain into a relay controlled latch. The gate is secured open with tension on the spring (spring-loaded). When the relay controlled latch is activated by the electronic controls the latch releases one end of the chain causing the gate to swing closed. The gate can swing close using gravity fall, or using a motor or hydraulic mechanism that is mechanically controlled by the virtual rancher.

Notwithstanding that the numerical ranges and parameters setting forth the broad scope of the present teachings are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 5. In certain cases, the numerical values as stated for the parameter can take on negative values. In this case, the example value of range stated as “less than 10” can assume negative values, e.g. - 1, -2, -3, -10, -20, -30, etc.

While the present teachings have been illustrated with respect to one or more implementations, alterations and/or modifications can be made to the illustrated examples without departing from the spirit and scope of the appended claims. For example, it will be appreciated that while the process is described as a series of acts or events, the present teachings are not limited by the ordering of such acts or events. Some acts may occur in different orders and/or concurrently with other acts or events apart from those described herein. Also, not all process stages may be required to implement a methodology in accordance with one or more aspects or embodiments of the present teachings. It will be appreciated that structural components and/or processing stages can be added or existing structural components and/or processing stages can be removed or modified. Further, one or more of the acts depicted herein may be carried out in one or more separate acts and/or phases. Furthermore, to the extent that the terms “including,” “includes,” “having,” “has,” “with,” or variants thereof are used in either the detailed description and the claims, such terms are intended to be inclusive in a manner similar to the term “comprising.” The term “at least one of” is used to mean one or more of the listed items can be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “conformal” describes a coating material in which angles of the underlying material are preserved by the conformal material. The term “about” indicates that the value listed may be somewhat altered, as long as the alteration does not result in nonconformance of the process or structure to the illustrated embodiment. Finally, “exemplary” indicates the description is used as an example, rather than implying that it is an ideal. Other embodiments of the present teachings will be apparent to those skilled in the art from consideration of the specification and practice of the disclosure herein. It is intended that the specification and examples be considered as exemplary only, with a true scope and spirit of the present teachings being indicated by the following claims.

What is claimed is:

1. An animal detection and trapping system comprising:
a spring loaded gate and relayed controlled latch subsystem;
an electronic controls and communications subsystem; and
a camera and image recognition subsystem.

2. The animal detection and trapping system of claim 1, wherein, the spring loaded gate and relayed controlled latch subsystem comprises:
a spring configured to be anchored to a gate at a first end and a fixed structure at a second end and pulling in a closed direction;
a chain configured to secure the gate open with tension on the spring; and
a relay controlled latch configured to release one end of the chain to swing the gate in the closed direction.

3. The animal detection and trapping system of claim 1, wherein the electronic controls and communications subsystem comprises:
a communications device;
an electronic controls configured to control the communications device;
a power source configured to power the communications device and electronic controls; and
one or more circuit breakers, power converters, relays and microcomputers.

4. The animal detection and trapping system of claim 3, wherein the communications device is a RF communications based system, and further includes a RF repeater.

5. The animal detection and trapping system of claim 1, wherein the camera and image recognition subsystem comprises;
a motion detector;
a camera to provide a camera feed; and
an image recognition system configured to use the camera feed for edge detection.

6. The animal detection and trapping system of claim 1 further comprising a computer program product comprising a computer readable storage medium having program instructions embodied therewith, the program instructions being executable by a computing device to cause the computing device to:
receive, via a network and by a computing device, data representing movement of animals within a pen; and
execute one or more operations based on receiving the data representing movement of animals with the pen.

7. The animal detection and trapping system of claim 6, wherein the computer program product executes one or more operations automatically upon receiving data representing movement of animals within the pen.

8. A method for trapping animals comprising;
detecting an animal within a trapping area by a camera subsystem;
generating an image using data provided by the camera subsystem and a machine learning enabled detection algorithm that can differentiate motion in the trapping area; and
sending a wireless signal to actuate a latch to trap the animal within the trapping area.

9. The method of claim 8 further comprising sending at least a portion of the image to a virtual platform.

10. The method of claim 8, wherein sending a signal to actuate the latch is calculated based on an artificial intelligence determination using information comprising one or more of time of day, location, number of animals inside trapping pen, number of animals outside cattle pen, and direction of movement of animals.

11. The method of claim 8, wherein the wireless signal is sent by an electronic controls and communications subsystem comprising:
a communications device;
an electronic controls configured to control the communications device;
a power source configured to power the communications device and electronic controls; and
one or more circuit breakers, power converters, relays and microcomputers.

12. The method of claim 8, wherein the signal is sent via a cellular network, a wifi network, a satellite network, or combinations thereof.

13. The method of claim 8, wherein actuating the latch includes releasing a chain that is attached to a gate in the trapping area.

14. The method of claim 8, wherein actuating the latch includes releasing a gate that falls by gravity closing trapping area.

15. The method of claim 8, wherein actuating the latch includes releasing a gate using a motor or hydraulic mechanism.
